(19) United States
(12) Patent Application Publication
(10) Pub. No.: US 2026/0241802 A1
(43) Pub. Date: Aug. 20, 2026

(54) METHOD FOR POWER LOSS DISPLACEMENT IN AN ELECTRIC DRIVE TRAIN

(71) Applicant: Dr. Ing. h.c. F. Porsche Aktiengesellschaft, Stuttgart (DE)

(72) Inventor: Maximilian THUM, Wiernsheim-Serres (DE)

(21) Appl. No.: 19/534,910

(22) Filed: Feb. 10, 2026

(30) Foreign Application Priority Data
Feb. 18, 2025 (DE) 10 2025 106 062.2

(51) Int. Cl. B60L 50/51; B60L 3/06; B60L 15/08; H02P 27/06

(52) U.S. Cl. CPC B60L 50/51; B60L 3/06; B60L 15/08; H02P 27/06; B60L 2240/421; B60L 2240/423

(57) ABSTRACT

A method provides power loss displacement in an electric drive train. The electric drive train includes an electric motor and a pulse inverter electrically coupled to the electric motor. The method includes adjusting a temperature of the electric drive train by dynamically adjusting a switching frequency of the pulse inverter, thereby preventing thermal derating of the electric drive train.

### CROSS REFERENCE TO RELATED APPLICATIONS

This application claims benefit to German Patent Application No. DE 10 2025 106 062.2, filed on February 18, 2025, which is hereby incorporated by reference herein.

### FIELD

The present invention relates to an electric drive train for power loss displacement and a motor vehicle having a corresponding electric drive train, and in particular to power loss displacement in an electric drive train, with the help of which the thermal derating of individual components can be prevented or delayed.

### BACKGROUND

Current electric drive trains for electric vehicles are known to independently limit the thermal stress on components. The switching frequency of the pulse inverter (PWR) is usually set statically or according to simple profiles, without dynamically exploiting the remaining temperature budgets of further components of the drive train. This leads to inefficient thermal utilization and early derating, especially in high power applications.

There is a constant need to reduce the thermal stress in electric drive trains and prevent or delay the thermal derating of individual components.

### SUMMARY

In an embodiment, the present disclosure provides a method for power loss displacement in an electric drive train. The electric drive train includes an electric motor and a pulse inverter electrically coupled to the electric motor. The method includes adjusting a temperature of the electric drive train by dynamically adjusting a switching frequency of the pulse inverter, thereby preventing thermal derating of the electric drive train.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic arrangement of a PWR and EM in an electric drive train;

FIG. 2 a schematic view of a first temperature budget of a PWR and EM according to FIG. 1;

FIG. 3 a schematic view of a second temperature budget of a PWR and EM according to FIG. 1; and

FIG. 4 a schematic view of a third temperature budget of a PWR and EM according to FIG. 1.

### DETAILED DESCRIPTION

Embodiments of the present disclosure provide a method for reducing the thermal stress of individual components in an electric drive train, with which the thermal derating of individual components can be prevented or delayed, that solves the constant need in the art.

In particular embodiments, the task is solved by a method for power loss displacement in an electric drive train, having an electric motor and a pulse inverter electrically coupled to the electric motor, wherein the temperature of the electric motor, in particular at least one component of the electric motor, and/or the pulse inverter is adjusted by dynamically adjusting the switching frequency of the pulse inverter in order to prevent thermal derating of the electric motor and/or the pulse inverter.

By adjusting the switching frequency of the pulse inverter in embodiments of the present disclosure, a power loss displacement between the electric motor and the pulse inverter is enabled. The adjustment is based on the temperature budget of the electric motor, in particular embodiments at least one component of the electric motor, and/or the pulse inverter, wherein the respective actual temperature of the components is monitored. The method ensures, by dynamically adjusting the switching frequency of the pulse inverter, that the thermal load on the components in the electric drive train is evenly distributed. This increases the performance and service life of the system.

Advantageous aspects are explained below and further described embodiments hereinafter. Explanations, particularly of advantages and definitions of features, are descriptive and preferred, but not limiting examples. If an explanation is limiting, this is expressly mentioned.

The order of method steps may be varied unless technically required in an explicit order. In particular embodiments, the method steps follow the aforementioned order of the method steps.

To the extent that ordinal numbers, for example “first”, “second”, etc., are used, for example, to designate a component, an element, a method step or a method action, these ordinal numbers are purely intended for differentiation in the designation and do not indicate any dependencies or sequences. That is in particular to say that, for example, a device need not have a “first component” in order to have a “second component”. Also, a device may have a “first component”, as well as a “third component”, but without necessarily having a “second component”. A plurality of units of the same ordinal number may also be provided, for example a plurality of “first components”.

In electric vehicles designed for performance, the electric drive train is often thermally limited. Especially at high temperatures, thermal derating leads to a limited availability of the maximum power. Embodiments of the present disclosure ensure a permanent availability of the maximum performance, even under demanding thermal conditions. The method or electric drive train is designed, in particular embodiments, for high-performance vehicles that must meet extreme thermal and mechanical requirements. This includes both short-term maximum loads (e.g., acceleration phases) and long-term loads (e.g., rotary operation).

In embodiments of the present disclosure, the electric motor is an engine, and in particular embodiments for a motor vehicle, that converts electrical energy into mechanical energy. The electric motor comprises at least one stator (fixed) and a rotor (rotating) which may be influenced by the switching frequency of the pulse inverter. The electric motor may be embodied as a high power motor and, in preferred embodiments, has separate cooling for the stator and the rotor. This allows better thermal separation of the losses in the electric motor and facilitates the targeted adjustment of the switching frequency of the pulse inverter.

The thermal losses in the electric motor can be divided into stator and rotor, even if the heat transfer and thermal radiation between the components leads to a common mixing temperature. In the rotor, losses are predominantly incurred in the iron and magnetic materials by eddy currents that are more pronounced at low clock frequencies. In the stator, on the other hand, losses occur in the copper of the coils due to so-called current displacement effects, which also occur intensified at low clock frequencies.

The pulse inverter forms a power electronic circuit that converts the DC current from a battery to AC power and drives the electric motor. The switching frequency of the pulse inverter determines the quality and efficiency of the signal, but also affects its thermal losses.

Thermal derating (sometimes referred to as “thermal power reduction”) refers to reducing the maximum power that a device, component, or system can supply or process to avoid overheating or thermal damage. This is a protective measure that ensures that the components involved operate reliably under the given thermal conditions. The derating limit thus represents the maximum allowable temperature of a component above which power is reduced to prevent thermal damage.

Alternatively or in addition, it can be provided that actual temperatures of the electric motor and the pulse inverter are continuously measured by means of at least one sensor unit, in order to monitor the thermal load of the electric motor and the pulse inverter in real time. This enables short reaction times to changes in the thermal conditions of the individual components and avoids delays. The at least one sensor unit comprises at least one temperature sensor for sensing temperatures. The at least one sensor unit is configured to transmit measurement data to a control unit. Through continuous monitoring, critical temperatures can be detected early and measures can be taken to avoid derating.

Alternatively or additionally, it may be provided that when the actual temperature of the pulse inverter approaches its derating limit, the switching frequency of the pulse inverter is reduced in order to reduce the power dissipation of the pulse inverter and displace it to the electric motor. If the actual temperature of the pulse inverter is consequently detected at its derating limit, the switching frequency of the pulse inverter can be lowered in order to reduce the power loss of the pulse inverter and displace it to the electric motor. This ensures that the thermal load on the pulse inverter decreases and the availability of maximum power is extended. Approaching can be understood to mean reaching the actual temperature of the derating limit or a predefined minimum temperature difference up to the derating limit. The pulse inverter can thus be protected from overheating by purposefully adjusting the switching frequency. In addition, the temperature budget of the electric motor may be efficiently utilized.

Alternatively or additionally, it may be provided that when the actual temperature of the electric motor approaches its derating limit, the switching frequency of the pulse inverter is increased in order to reduce the power loss of the electric motor and displace it to the pulse inverter. If the actual temperature of the electric motor is detected at its derating limit, the switching frequency of the pulse inverter is increased in order to reduce the power loss of the electric motor, and in particular embodiments the rotor and stator losses, and to displace it to the pulse inverter. Approaching can be understood to mean reaching the actual temperature of the derating limit or a predefined minimum temperature difference up to the derating limit. This ensures that the thermal load on the electric motor is decreased and the availability of maximum power is extended. Thus, by purposefully adjusting the switching frequency of the electric motor, overheating can be protected. In addition, the temperature budget of the pulse inverter can be efficiently utilized. Consequently, the electric motor may be protected from overheating while better utilizing the thermal capacity of the pulse inverter.

Alternatively or additionally, it may be provided that the switching frequency is adjusted by a control unit of the pulse inverter, wherein the control unit is configured to continuously compare the respective actual temperatures of the electric motor and the pulse inverter with the respective derating limits of the electric motor and the pulse inverter and to adjust the switching frequency of the pulse inverter upon reaching a predefined minimum temperature difference between the respective actual temperatures and derating limits of the electric motor and the pulse inverter. The switching frequency is thus adjusted by a control unit of the pulse inverter. The control unit is configured to continuously compare the respective actual temperatures of the components with the respective derating limits. When a predefined minimum temperature difference is reached, the control unit adjusts the switching frequency. Thus, the control unit allows precise and automatic control of the electric drive train.

Alternatively or additionally, it can be provided that the control unit adjusts the switching frequency of the pulse inverter at an early stage, and in particular embodiments before reaching the respective derating limit, taking into account the respective derating limit and taking into account the actual temperatures as well as the power dissipation models of the electric motor and the pulse inverter. The control unit thus predicts performance limits by developing the actual temperatures of the electric motor and the pulse inverter. This prediction can be addressed early so that the temperature budgets can be used evenly. The power loss model is, in particular embodiments, a model that describes the dependence of the losses on the switching frequency. Predictive control allows early adjustment of the switching frequency in the electric drive train and thus prevents abrupt performance degradation.

Embodiments of the present disclosure further solve the task by an electric drive train for power displacement, in particular embodiments according to the method, which may be formed and further formed as described above, with an electric motor and a pulse inverter electrically coupled to the electric motor, comprising:

at least a first sensor unit for detecting the actual temperatures of the electric motor;

at least one second sensor unit for detecting the actual temperatures of the pulse inverter;

a control unit configured to adjust the switching frequency of the pulse inverter based on the detected actual temperatures to prevent thermal derating of the electric motor and/or the pulse inverter.

Detecting the actual temperatures of the electric motor includes, in particular embodiments, detecting the temperature of the stator and/or the rotor as these components represent the main sources of thermal losses in the electric motor. The detection of the actual temperatures of the pulse inverter is, in particular embodiments, focused on the power semiconductors, as they are thermally stressed by switching and conductive losses to an increased degree. The control unit is, in particular embodiments, configured to dynamically adjust the switching frequency of the pulse inverter based on the detected actual temperatures in order to prevent a thermal derating of the electric motor and/or the pulse inverter. The combination of sensor units and control unit allows precise and automated control of the switching frequency. By monitoring the temperature in real time, overheating and power restriction can be avoided early. The sensor units continuously provide the required measurement data to optimally utilize the temperature budget of the electric motor and the pulse inverter.

Alternatively or additionally, the control unit may be configured to dynamically increase or decrease the switching frequency of the pulse inverter in order to displace the power loss in favor of the thermally less stressed component, electric motor or pulse inverter when the respective actual temperature approaches the respective derating limit of the electric motor and/or the pulse inverter. This is done depending on the respective actual temperatures approaching the respective derating limits of the components. The switching frequency of the pulse inverter is always increased when the electric motor is subjected to a high thermal load. This reduces rotor and stator losses in the electric motor and postpones the thermal load on the pulse inverter. A decrease in the switching frequency of the switching frequency can be always carried out when the pulse inverter is subjected to a thermal load. This reduces the switching losses in the pulse inverter and displaces the thermal load to the electric motor. The dynamic adjustment of the switching frequency allows a uniform thermal loading of both components. Critical temperatures are avoided, thereby extending the service life of the components. Thus, the electric drive train remains efficient for longer, even under high thermal loads, and in particular embodiments in continuous operation and/or at high speed ranges of the electric motor.

Alternatively or additionally, the control unit may consider thermal models of the rotor and stator losses of the electric motor and the switching and conductive losses in the pulse inverter to ensure optimum adjustment of the switching frequency. The thermal models include, in particular embodiments, rotor losses, stator losses, switching losses, conductive losses, and/or the like. Rotor losses are losses from eddy currents in the rotor of the electric motor that are affected by the switching frequency of the pulse inverter. Stator losses are losses from current displacement effects in the coils of the electric motor that are also frequency-dependent. Switch losses are losses in the pulse inverter that increase with increasing switching frequency. Conductive losses are losses in the pulse inverter that dominate at low switching frequency. The thermal models allow an accurate prediction of the temperature development in both components during a change in the switching frequency. Based on the models, the control unit can preventively adjust the switching frequency before critical temperatures are reached. This may improve the efficiency and reliability of the electric drive train.

Embodiments of the present disclosure include a motor vehicle having an electric drive train, which may be formed and further formed as described above.

An exemplary technical solution will be discussed in more detail below with reference to the accompanying drawings using exemplary embodiments. The formulation “Figure” is abbreviated to “Fig.” in the drawings.

The exemplary embodiments described are merely examples that can be modified and/or supplemented in a variety of ways within the scope of the claims. Any feature described for a particular exemplary embodiment may be utilized independently or in combination with other features in any other exemplary embodiment. Any feature described for an exemplary embodiment of a particular embodiment category may also be employed in a corresponding manner in an exemplary embodiment of a different embodiment category.

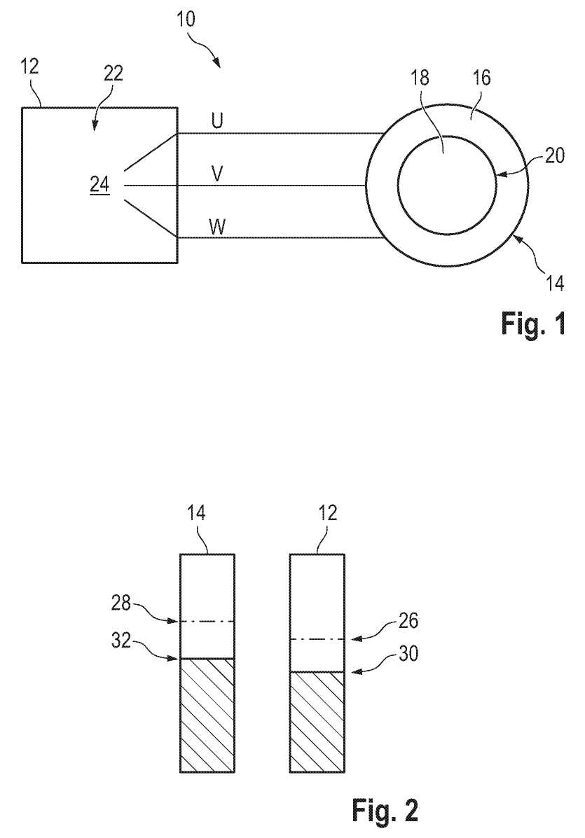

FIG. 1 shows a schematic arrangement of a PWR 12 and EM 14 in an electric drive train 10, wherein the EM 14 is configured as a multi-phase AC motor and is electrically connected to the PWR 12 via phases U, V, W. The EM 14 comprises a stator 16 and a rotor 18 for converting electrical energy into mechanical energy and for providing a torque in the motor vehicle, wherein the respective temperatures of the stator 16 and the rotor 18 generate a mixing temperature 20 in the EM 14. The PWR 12 itself has a temperature 22, wherein the temperatures of the EM 14 and the PWR 12 are adjustable by means of the switching frequency 24.

FIG. 2 shows a schematic view of a first temperature budget of a PWR 12 and EM 14 according to FIG. 1, wherein the PWR 12 and EM 14 each have different derating limits 26, 28. The actual temperatures 30, 32 detected by means of a sensor unit are below the respective derating limits 26, 28. The first temperature budget thus shows an evenly distributed temperature loading of the individual components.

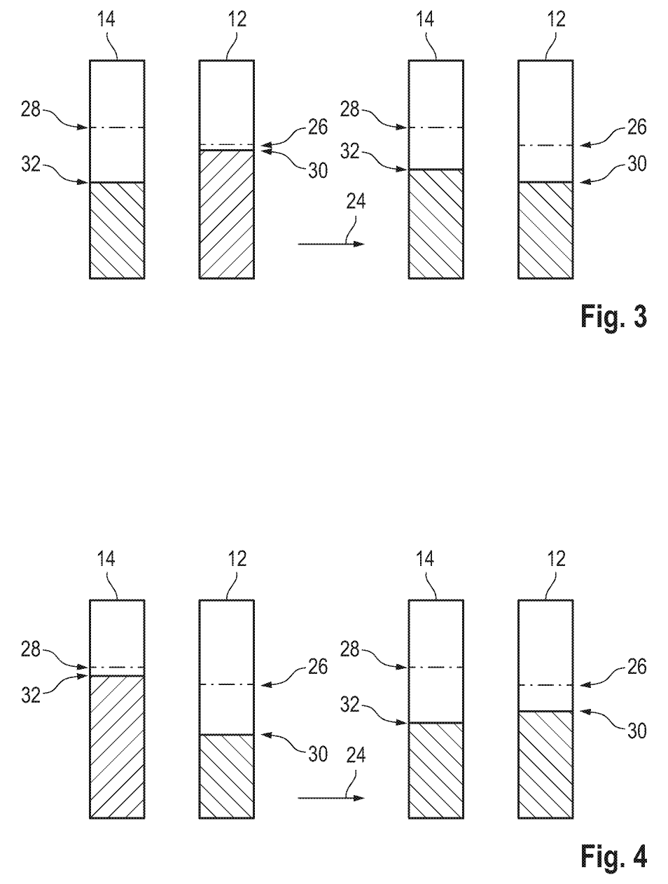

FIG. 3 shows a schematic view of a second temperature budget of a PWR 12 and EM 14 according to FIG. 1, wherein the temperature loading of the PWR 12 is in the specific case larger and the actual temperature 30 has approached the derating limit 26 of the SWR 12 very much. By decreasing the switching frequency 24, the temperature budget can be balanced again by raising the actual temperature 32 of the EM 14 and decreasing the actual temperature 30 of the PWR 12.

FIG. 4 shows a schematic view of a third temperature budget of a PWR 12 and EM 14 according to FIG. 1, wherein the temperature load of EM 14 is in the specific case larger and the actual temperature 32 has significantly approached the derating limit 28 of EM 14. By increasing the switching frequency 24, the temperature budget can be balanced again by raising the actual temperature 30 of the PWR 12 and lowering the actual temperature 32 of the EM 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for power loss displacement in an electric drive train, the electric drive train comprising an electric motor and a pulse inverter electrically coupled to the electric motor, the method comprising:
adjusting a temperature of the electric drive train by dynamically adjusting a switching frequency of the pulse inverter, thereby preventing thermal derating of the electric drive train.

2. The method according to claim 1, further comprising:
continuously detecting an actual temperature of the electric motor and the pulse inverter by at least one sensor unit, thereby monitoring a thermal load of the electric motor and the pulse inverter in real time.

3. The method according to claim 1, further comprising:
lowering the switching frequency of the pulse inverter when an actual temperature of the pulse inverter approaches a derating limit of the pule inverter, thereby reducing a power loss of the pulse inverter and displacing the power loss to the electric motor.

4. The method according to claim 1, wherein adjusting the switching frequency further comprises:
increasing the switching frequency of the pulse inverter, when an actual temperature of the electric motor approaches a derating limit, thereby reducing a power loss of the electric motor and displacing the power loss to the pulse inverter.

5. The method according to claim 1, wherein the switching frequency is adjusted by a control unit of the pulse inverter, wherein the control unit is configured to compare respective actual temperatures of the electric motor and the pulse inverter having respective derating limits of the electric motor and the pulse inverter and adjust the switching frequency of the pulse inverter when reaching a predefined minimum temperature difference between the respective actual temperatures and the respective derating limits of the electric motor and the pulse inverter.

6. The method according to claim 5, wherein the control unit, based on the respective actual temperatures and power loss models of the electric motor and the pulse inverter and based on respective derating limits of the electric motor and the pulse inverter, adjusts the switching frequency of the pulse inverter at an early stage.

7. An electric drive train for power loss displacement according to the method according to claim 1, comprising the electric motor and the pulse inverter electrically coupled to the electric motor, comprising:
at least a first sensor unit for detecting actual temperatures of the electric motor;
at least one second sensor unit for detecting actual temperatures of the pulse inverter; and
a control unit configured to adjust the switching frequency of the pulse inverter based on the detected actual temperature of the electric motor and the detected actual temperature of the pulse inverter to prevent thermal derating of the electric motor or the pulse inverter.

8. The electric drive train according to claim 7, wherein the control unit is further configured to dynamically increase or decrease the switching frequency of the pulse inverter in order to displace a power loss in favor of a component, the electric motor or the pulse inverter with a lower thermal load when the respective actual temperature of the electric motor or the pulse inverter approaches a respective derating limit of the electric motor or the pulse inverter.

9. The electric drive train according to claim 7, wherein the control unit is further configured to adjust the switching frequency based on thermal models of rotor and stator losses of the electric motor and switching and conductive losses in the pulse inverter.

10. A motor vehicle comprising the electric drive train according to claim 7.

11. The method according to claim 1, wherein adjusting the temperature of the electric drive train further comprises adjusting at least one component of the electric motor or pulse inverter.

12. The method according to claim 1, wherein preventing thermal derating of the electric drive train further comprises thermal derating of the electric motor or the pulse inverter.
